(19) United States
(12) Patent Application Publication
(10) Pub. No.: US 2005/0289112 A1
(43) Pub. Date: Dec. 29, 2005

(54) Method and system for organizing and distributing lists of linked or embedded content

(75) Inventors: Benjamin B. Sargent, Framingham, MA (US); Diane M. McAveeney, New York, NY (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: eLegal Arts, Inc., New York, NY (US)

(21) Appl. No.: 11/146,409

(22) Filed: Jun. 6, 2005

Related U.S. Application Data
(60) Provisional application No. 60/577,436, filed on Jun. 4, 2004.

(51) Int. Cl. G06F 17/30

(52) U.S. Cl. 707/1

(57) ABSTRACT

Systems and methods are described for organizing and distributing lists of linked or embedded content, which may include digital media assets and/or attendant reviews of the content or linked material, and for enabling the organizers of the lists to receive compensation based on commercial transactions that occur when consumers make purchase decisions as a result of interacting with listed content.

### RELATED APPLICATIONS

This application claims priority to U.S. Provisional Application No. 60/577,436, entitled Method and System for Organizing and Distributing Lists of Linked or Embedded Content, filed on Jun. 4, 2004, which application is incorporated herein by reference.

### BACKGROUND OF THE INVENTION

Consumer behavior in the field of musical recordings is in the midst of a major shift from the purchase of physical media (typically disks, such as record albums or compact discs) to downloaded data (a downloadable MP3 file, for example). This shift is causing a major disruption in the distribution, supply and demand for recorded music. The failure of distributors to address this shift is one factor causing consumers to engage in the apparently wide spread behavior of downloading or sharing recorded music files in violation of the copyright laws.

Currently, a number of music retailers (Apple, Real, Buy.com, Sony, Napster, and others) are flooding the market with new, online stores loaded with songs (and a variety of bells and whistles) to attract consumers. But consumers who fail to realize tangible benefits from these new online stores will soon look for better alternatives. None of these sites yet offers a service compelling enough to retain their users against a strong value proposition. The continued launch of new rounds of subpoenas by the music industry suggests that illegal downloading continues despite the presence of these new outlets.

In the world of digital content that is always available, the consumer's first question is no longer “what's on?”—instead, it becomes “what's good?” Today's entertainment services fail to answer the question “what's good?”

Online music retailers, such as iTunes and its imitators, spend an inordinate amount of money and effort building stores to service the presumed need for content. The focus of these retail sites is to offer over 1,000,000 songs: they believe that bigger is better, and hope that better is good enough. These services do not have a compelling value-proposition for their for their customers—they do little or nothing to help consumers answer the question “What's good?” Advertising campaigns for these service exemplify their own perceived value-propositions: “Buy music without a credit card,” “over 1,000,000 songs,” and “best music selection online” are examples of recent ad pitches.

To make matters worse, the shift to downloadable entertainment appears set for an acceleration. Some project that, perhaps as soon as 2008, music, movies and games may become fully accessible via the Internet. The televisions and stereos of the past may be replaced by the integrated components of a “wired” home theater system that manages “always-on” subscriptions to digital content. Moreover, this situation is not limited to digital goods. Rather, with retail chains losing their ability to offer the broad selection consumers crave, the destination sites that capture user loyalty will increasingly fulfill consumer needs for hard goods as well.

There is a need in the marketplace for a distribution system that will help consumers to find the entertainment or goods online that they consider “good,” and to do so legally.

### SUMMARY OF THE INVENTION

The present invention improves on known distribution systems by providing methods and systems for organizing and distributing lists of linked or embedded content, which may include digital media assets and/or attendant reviews of the content or linked material, and for enabling the organizers of the lists to receive compensation based on commercial transactions that occur when consumers make purchase decisions as a result of interacting with listed content.

The invention involves the organization, distribution and use of lists. In one embodiment, the list can be a play list for songs. In other embodiments, the lists could be book lists for books, image lists for photographs or other images, movie lists for movies, game lists for games, and tv lists for television shows. A list could also be a list of luggage products that would be useful for business travelers, or lists of other hard goods that are not available in a digital format.

Users of the invention may wish to make their own lists, and the invention provides the tools for users to do so. Many users, however, will prefer to sample the lists of others who are “in the know” to find new content or goods that are “good.” The lists most useful to users are likely to be those, in the context of music for example, that combine artists or songs that the user already enjoys with new songs or artists that the user has yet to discover, but might enjoy based on the favorite songs or artists that the user has in common with the user who organized the list. This is one of the basic principles by which users can find out “what is good,” by using the lists organized by people whom the user considers to have good taste.

The distribution systems and methods of the invention also track purchases made by users from the lists distributed. In this way, the organizer of a list can be compensated for sales driven by that person's lists. This creates an incentive not only for users to make lists, but for users to make popular lists and to be evangelists for the content associated with their lists—in essence, driving “good” content to users who are looking for good, new content to purchase.

### BRIEF DESCRIPTION OF THE FIGURES

FIG. 1 provides a diagram of a system of the invention;

FIG. 2 provides a registration data collection form useful with the invention;

FIG. 3 provides a form useful with the invention for creating a list;

FIG. 4 provides a form useful with the invention for adding items to a list;

FIG. 5 provides a form useful with the invention for adding items to a list from other than a catalogue;

FIG. 6 provides a form useful with the invention for adding a review for an item;

FIG. 7 illustrates a completed list as stored by a system of the invention;

FIG. 8 provides a form useful with the invention for presenting a list to a consumer;

FIG. 9 illustrates a payment calculation for a consumer purchasing an item from a list on a system of the invention;

FIG. 10 illustrates a fee tracking and payment system useful with the invention;

FIG. 11 illustrates Jockey list of the invention; and

FIG. 12 illustrates a playlist of the invention.

### DETAILED DESCRIPTION OF THE INVENTION

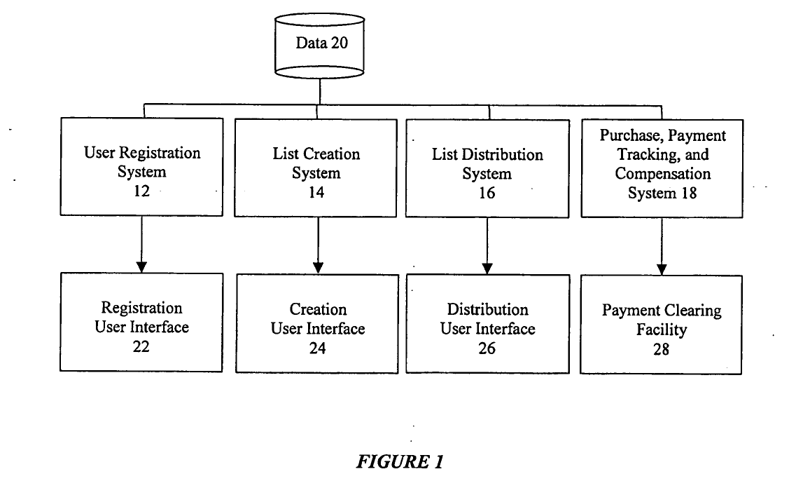

A system of the invention can be illustrated in a functional block diagram as provided in FIG. 1. In general, the invention includes elements or steps for the creation and use of lists where elements in the list include or are linked to items that may be purchased. In addition, purchasing activity is tracked and creators of lists from which items are purchased may be compensated for such purchases. A system of the invention may thus include a user registration system 12, a list creation system 14, and a list distribution system 16, with each of these systems having respective user interfaces, 22, 24, and 26. As the lists include one or more items that are available for purchase, a purchase, payment tracking, and compensation system 18 can be provided to allow users to purchase items from the lists, and to track payment for the purpose of providing compensation to the creators of lists from which items are purchased. This system 18 can be linked to a payment clearing facility 28 for the processing of payments as desired. Each of the systems 12, 14, 16, and 18 is preferably connected to a data store, such as one or more relational database systems, for the purpose of storing user, list and payment information.

In one embodiment according to the present invention, a system of the invention can be deployed on server computers, such as a linked farm of multiple Dell PowerEdge 2650. Servers running Microsoft SQL Server 2000. Enterprise Edition under the Microsoft Windows 2003 operating system. Such a system could generally include interface and processing software, database code, and data structures as required in order to carry out the functions described below.

Users may interact with a system of the invention through the illustrated user interfaces using a variety of communication means. In one embodiment, users interact with the present invention via World Wide Web information browsers which run on a variety of personal computing or other digital platforms. The browsers, which allow for display and interaction with content comprising of Hypertext documents and standardized and custom client applications, are used to send and receive information from the system through HTTP or similar protocols through public or private Internet connections. In one particular embodiment, a system user utilizes the Microsoft Internet Explorer web browser utilizing the Microsoft Windows 2000 Professional operating system on a Dell Dimension model L733r personal computer which sends and receives data from the system via HTTP through a connection to the public Internet enabled through commercial ISP data connection services provided by AT&T. The use of alternative browsers such as Opera, Netscape Navigator, Blaze and others running on a wide range of computing or other digital devices are envisioned as part of the present invention.

In further embodiment, a system user may connect using Short Message Service (SMS) messages sent and received from a wireless handheld device such as, for example, a Nokia 3595 model handset, connecting via a Global System for Mobile (GSM) network such as that as provided by AT&T Wireless Services (ATTWS; now owned by Cingular Wireless LLC of Atlanta, Ga.) utilizing ATTWS's standard SMS gateway to connect via Simple Mail Transfer Protocol (SMTP) over the public Internet to reach the system.

In another embodiment, a user may use the same wireless handheld device (in this example a Nokia 3595 model handset), but now connecting using mMode wireless Internet access as provided by ATTWS using a custom gateway as a proxy to standard Hypertext Transfer Protocol (HTTP) for connecting to the system through the public Internet. In yet other embodiments, users can connect utilizing data and text services provided through a variety of carriers using an appropriate cellular telephone, connecting through a matching proxy or gateway, using standard communications protocols through either dedicated or public Internet connections to the system.

A further alternative means for a user to interact with the system is via a different wireless handheld device such as a Palm i705 wireless personal digital assistant which, when running a custom application as part of this invention, offers wireless service using infrastructure provided by Palm.Net to provide a standardized proxy interface to HTTP communications serviced by the system.

Yet another means of access to the system by users is through the use of commercial, free, or customized Instant Messaging Services. In one embodiment, a user may utilize the AOL Instant Messaging Client on a Dell Dimension model L733r personal computer under the Microsoft Windows 2000 Professional operating system to communicate with the invention's system through standardized intermediate protocols as defined by the instant messaging service provider requirements. This communication means (as well as the computer based means described below), could be wired, wireless, or a combination of wired and wireless (such as a connection through a Wi-Fi “hot spot” to a wired network).

An additional method for users to interact with the present invention is through the use of standard electronic mail (e-mail) through the use of a personal computer such as a Dell Dimension model L733r personal computer under Microsoft Windows 2000 Professional utilizing a communications program-such as Microsoft Outlook 2000 to send and receive e-mail through a commercial Internet Service Provider utilizing standard protocols such as SMTP and Post Office Protocol 3 (POP3). Other similar configurations of e-mail software, ISPs, and standard communication protocols are anticipated as part of the current invention.

What follows is a detailed description of an exemplary implementation of the user registration system 12, list creation system 14, and list distribution system 16 of the invention.

One first step or first element for users wishing to interact with a system of the invention may be registering using the user registration system 12. The registration process is preferably applicable to all users of the invention, however, it may be applied only to those who organize lists or to those who use lists, or the registration process might collect different types of information from differing types of users.

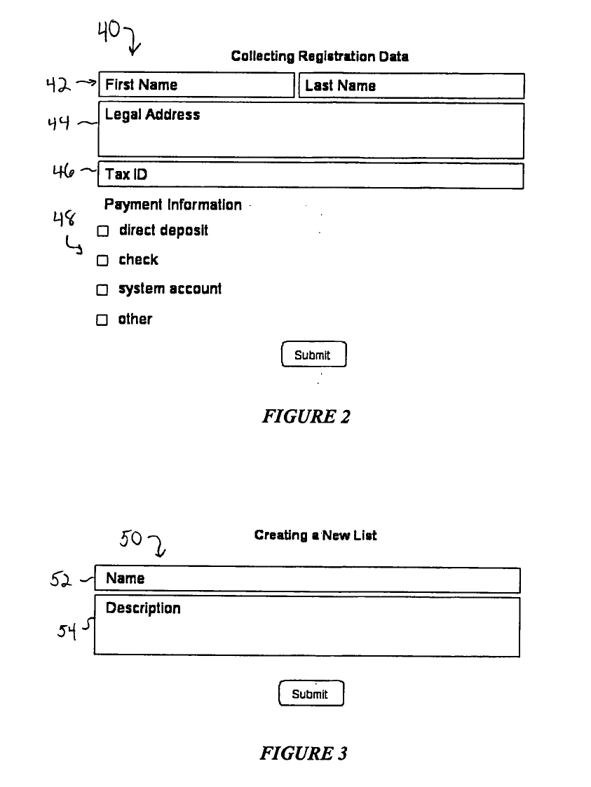

One exemplary form 40 for collecting registration data, particularly a form useful for collection of registration data on the Web, is provided in FIG. 2. Although a Web-based form may the best method for collecting registration data, other methods can be used, including telephone and paper-based forms. The following data can be collected in order to register a user to build lists:
Legal name 42 and address 44;
Tax ID 46; and
Payment Info 48 (direct deposit, reverse credit, system account, PayPal or equivalent).

A user can be registered in other ways than by using a form as well. For example, a user registering for a service (a mobile telephone subscription for example), registering on an affiliated Web-site, or becoming a customer of another product or service (taking out a car loan for example) can be automatically registered with a system of the invention.

Once the user is registered, a system of the invention can allow the registered user to create a new list. An exemplary form 50 for creating a list is provided in FIG. 3.

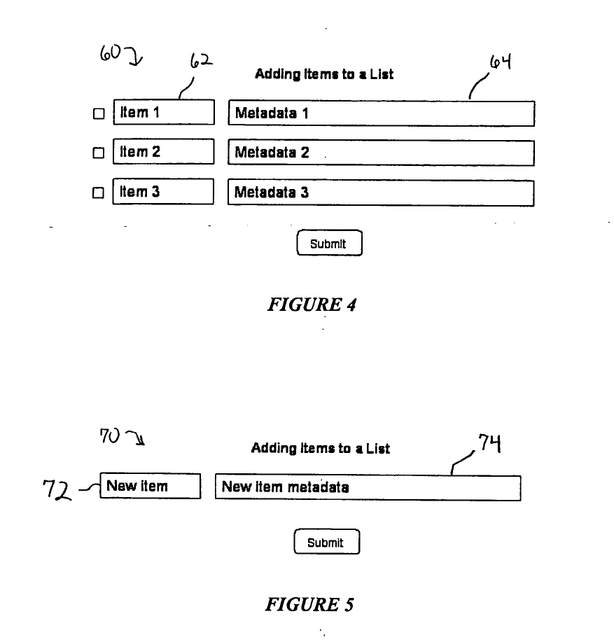

Each list preferably has a unique identifier, in the case of the illustrated form, a name 52. A description field 54 is also preferably provided for the list creating user to include a stated objective or purpose. Once created, the user may add items to the list, using, for example, the form 60 illustrated in FIG. 4. This exemplary form allows users to add an item 62 to the list, and also metadata 64 relating to the item.

In one embodiment of the invention, two methods can be provided for adding an item to a list. The first method is to allow the user to add items from a catalog. The items may be selected directly from a complete catalog listing, or from a subset of the catalog such as results from a catalog search.

Items may include complete digital media assets and/or sample content (incomplete digital media assets). Items may be accompanied by images (cover art) or text (artist, publisher, year, etc.) that serves to identify and inform. This information that may accompany the digital media asset is called metadata. Some or all of the metadata can be incorporated from the catalog into the list.

The second method for allowing users to add items to a list can be to allow the user to add unique items not already in the catalog. An example form 70 for allowing a user to do so is illustrated in FIG. 5. The new item 72 may be placed into the list by uploading a digital media asset, or simply by cutting and pasting a text object that may embody a link or other information identifying or allowing a user to purchase the new item. Metadata 74 relating to the new item may also be added.

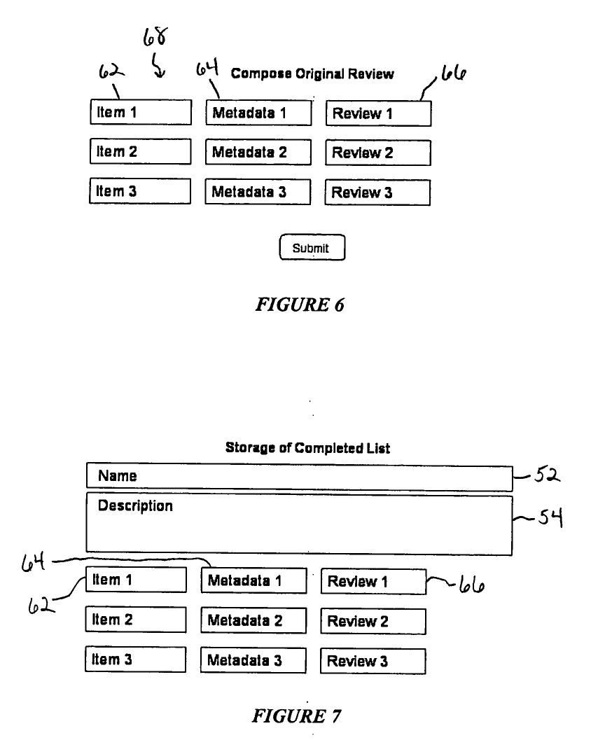

A system of the invention can also allow the list creating registered user to compose an original review 66 for each item 62 added to the list as illustrated in the exemplary form 68 of FIG. 6.

At this point in an exemplary process of the invention, the list comprises a name 52, a description 54, and a list of items 62 including metadata 64 and reviews 66 for each. A system of the invention can store completed lists and maintain the linkage between each asset or link, the associated metadata, and the registered user's original review for that item as illustrated in FIG. 7.

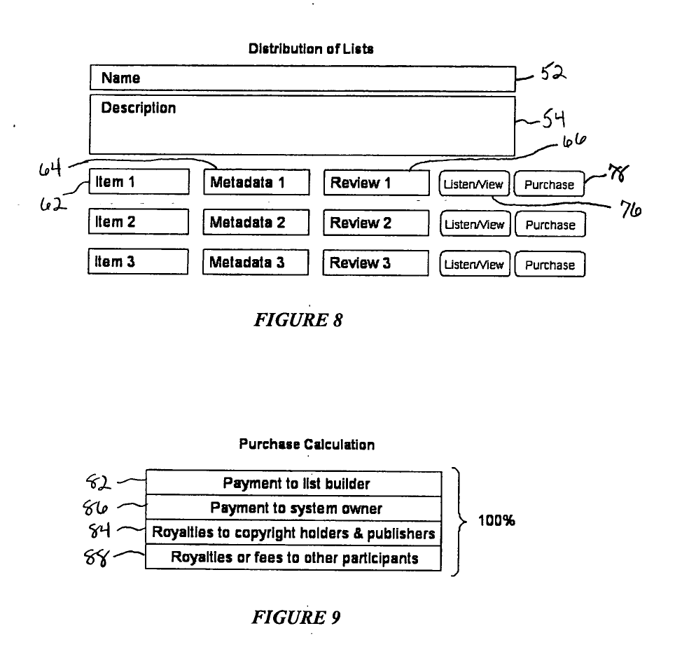

Once one or more lists have been created within a system of the invention, the system can distribute the lists to allow end users (consumers) to interact with the content associated with the lists, whether by reading or listening or viewing or any combination of the above. Although a Web-based form is one preferably format for distribution, other forms are also viable, including but not limited to: e-mail, telephones, and interactive television. A form 80 for presenting a list to a consumer is provided in FIG. 8. This form includes the name 52 and description 54 of the list, as well as the items 62 belonging to the list with their associated metadata 64 and individual review 66, if any. Each item in the list on form 80 also includes a means for “previewing” the item 76. Where the list is a list of songs, this previewing might include allowing the consumer to listen to a sample. If the item is a hard good, the previewing might include providing a picture or operating manual or some other information that would allow the consumer to understand better the features of the item.

Distribution of the lists can be performed using any of the methods described for user interaction with a system of the invention described above. In one embodiment, lists can be distributed through the Web, with users browsing through a catalogue or other groupings of lists to find those of interest. Searching and recommendation features could also be included to help users find the right lists. Lists could also be distributed through email, with users subscribing (generally, by indicating specific list creators or lists that include certain kinds of items that interest that user) for periodic publications of lists in an email format. In addition, a video presenting lists could be provided through broadband Internet connectivity or through a television.

In cases where the distribution affords minimal viewability (e.g., mobile phone displays), lists may be delivered in a “compact form” in which only the digital media assets and a subset of the metadata (e.g., titles) are distributed, without reviews or list descriptions. This would allow, for instance, a list of songs to be played in order via a telephone, with option to purchase, but without the reviews, text, or images being displayed.

Notably, the system distributes lists to consumers in a transaction-ready framework. The distribution framework allows consumers to interact with the content (e.g., listen to songs or clips, or view book passages or video), and then select specific items for immediate purchase. Purchased goods may be delivered (a) directly from the system (via download or “video on demand”), (b) indirectly through a third-party fulfillment house (CDs, DVDs, or books shipped by common carrier), or (c) indirectly via another Web-based service. Accordingly, form 80 also includes for each item a means for purchasing the item 78.

The system allows consumers to purchase rights (e.g., End User License Agreements) to digital media assets, and also other items related to the content and reviews found in a list (hard goods, tickets, etc.). These assets and other items may be purchased individually or in bundles, via direct purchase or by subscription. The system can also allow lists where the items are, and the accompanying reviews describe, services, such as a restaurant, hotel, spa, bank, transportation, education program, legal or medical services, car repair, etc. These services could then be purchased directly (directly on-line or by subscription or gift certificate) or links could be provided for purchasing the services.

Each time a consumer makes a purchase while viewing or hearing a list, the system calculates a fee 82 (e.g., sales commission), as shown in FIG. 9, to be paid to the individual (or assignee) responsible for having built that list. This fee is only one cost component of the transaction. Other cost components may include royalties 84 to publishers and copyright owners, the system owner 86, distribution partners, e-commerce partners, and so forth 88.

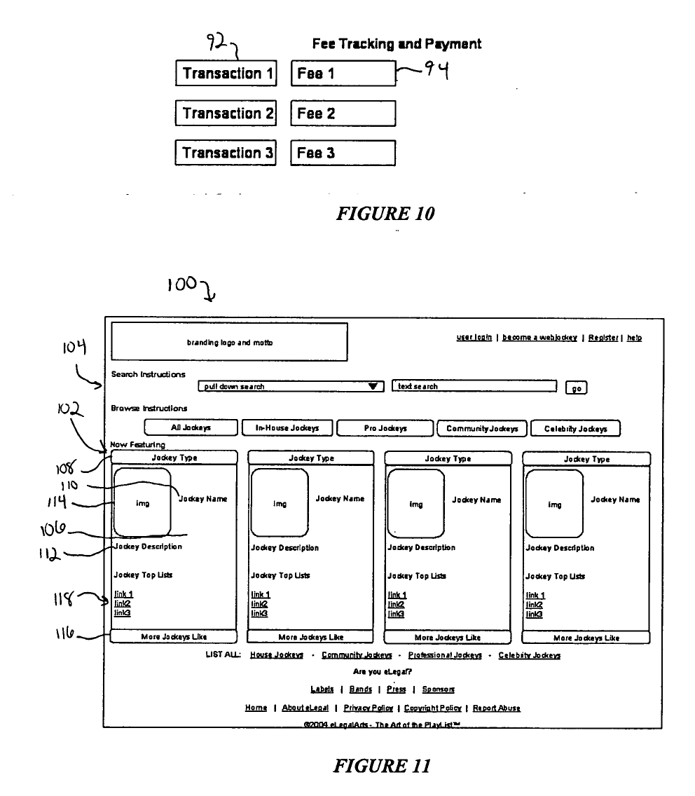

Each time a fee calculation 92 is made on behalf of a registered user, the fee 94 is tracked, as shown in FIG. 10, for payment to that user's account. Payments can be made according to the user's preference for payment 48 as illustrated in the registration data form 40 illustrated in FIG. 2. Payments may be made in real-time, or accumulated and paid via batch.

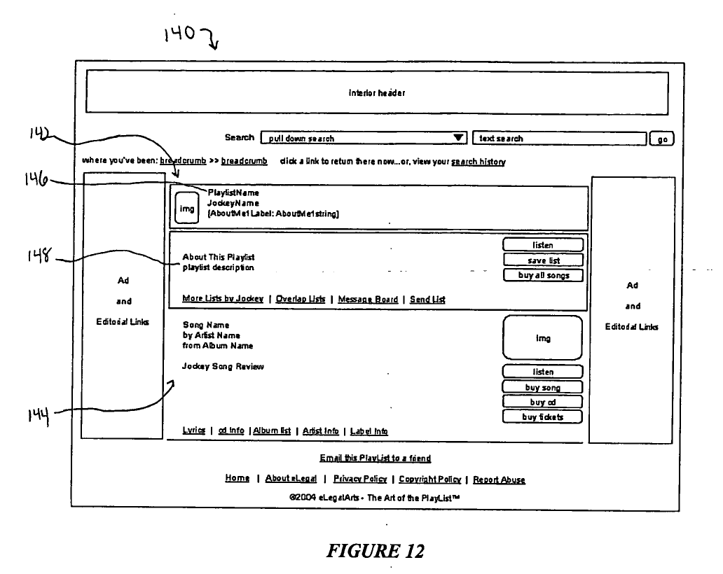

A more detailed example of an embodiment of the invention is illustrated in FIGS. 11 and 12. In this embodiment, the lists are playlists of songs, and the list builders are referred to as Jockeys. FIG. 11 provides a form 100 for locating Jockeys and lists. In the first instance, “featured” Jockeys 102 may be displayed for consumers that are selected by an editor of the system, based on the editor's view of what consumers would like to see, or based on objective parameters such as the “most viewed” Jockey or list, or Jockeys or lists having the largest number of song purchases. Searching means 104 may also be provided. The searching means may allow a consumer to search for lists containing certain songs or artists, or for lists by particular Jockeys. The searching means may also allow the consumer to browse within certain narrowly defined categories for Jockeys or lists that meet the criteria of those categories to help focus the consumer toward content that will be interesting to that consumer. Broader categories, such as all “Celebrity Jockeys,” may also be selected and browsed by the consumers.

Each Jockey display 106 can include a jockey type 108 (such as Pro Jockey or Celebrity Jockey), a jockey name 110, a jockey description 112, and an image 114. In general, the name, description and image are entered by the Jockey to convey the artistic style of the Jockey and also to attract consumers who might be interested in that style to browse the Jockey's playlists. The Jockey display 106 can also include a link or search button 116 that will allow the consumer to browse additional Jockey displays that are similar to Jockey display 106 based on characteristics that may be selected by the editor or the Jockey. The Jockey display 106 also includes links to one or more lists 118 created by that Jockey.

Selecting a list 118 (either directly from Jockey display 106 or by selecting a particular Jockey to browse all lists created by that Jockey) will result in the presentation of a List display 140 that provides an information display about the list 142 as well as a display of information 144 for the items (here, songs) on the list. The list information display 142 can include the playlist name 146, as well as information about the jockey who created the list. The list information display 142 can also include the Jockey's description of the list 148, as well as options to preview or listen to the items on the list, save the list, and/or buy all of the songs on the list. The list information display 142 can also include further browsing options, including viewing all lists by the Jockey who created this list or finding other lists having items in common with this list. The list information display can also include options to send or email the list to others, or to post messages about the list to a message board designated for this purpose.

The item information display 144 provides information about and options to purchase the songs on the playlist. Typical information can include the song name, the artist name, the album/cd on which the song is distributed, an image (typically “cover art” from the album/cd). The item information display 144 can also include, a review for that song written by the Jockey who built the list. Each song display can also include links to further information, such as lyrics for the song, information about the album/cd from which the song is taken, information about the artist, or information about the Label that distributes the song. The consumer can also be provided with an option to listen to a sample of the song.

The item information display also includes purchasing options for the song. One option is to allow the consumer to buy the song. As published songs can generally be made available as downloadable digital assets, the user can be allowed to download the song in a desired format with payment arranged on a per song basis (pay-per-download), as a charge against a debit account, as a set off against a subscription, or by other services known in the art such as PayPal. One source of access to digital to published songs is the Loudeye Media Framework made available by Loudeye Corp. of Seattle, Wash. This service can be integrated into a system of the invention to provide full song downloads, streaming song previews, cover art, and other metadata.

A consumer may also be given the option to purchase the album/cd on which the song is published. This option can be fulfilled by providing a download of the album/cd, or by shipping a compact disc or other physical media to the consumer. Still further, the consumer can be linked to a further service for purchasing tickets to events relating to the song or artist.

While this embodiment provides certain details as to one implementation of a system and method of the invention, a person skilled in the art will understand that the features and advantages of the invention described above, in particular the ability to pay list building users based on purchases made from their lists but also other features, can be combined with this embodiment.

In addition, list builders may be charged a fee for access to the list building and distribution features from which they may derive a revenue stream. Still further, list builders having the ability to drive sales of items may be paid for building and distributing lists.

A person of ordinary skill in the art will appreciate further features and advantages of the invention based on the above-described embodiments. For example, specific features from any of the embodiments described may be incorporated into systems or methods of the invention in a variety of combinations, as well as features referred to in the claims below which may be implemented by means described herein. Accordingly, the invention is not to be limited by what has been particularly shown and described, except as indicated by the appended claims or those ultimately provided. Any publications and references cited herein are expressly incorporated herein by reference in their entity.

1. A system for organizing and distributing lists of purchasable items included a networked computer system comprising:
a list creation system for allowing list creating users to create lists of purchasable content;
a list distribution system that provides lists to consumer users in a format that allows the user to purchase an item on a distributed list by interacting with the distributed list; and
a purchase, payment tracking and compensation system that allows a consumer user to pay for a purchased item from a distributed list, tracks payments made for items from distributed lists, and facilitates payment of compensation to respective list creating users based on payments made to purchase items from lists created by the respective list creating users.

2. The system of claim 1, further including a user registration system for registering users.

3. The system of claim 1, wherein the lists include digital content embedded within the list for purchase.

4. The system of claim 1, wherein the lists include links to downloadable content for purchase.

5. The system of claim 1, wherein the lists include links to shipping systems for delivery of purchased items.

6. The system of claim 1, wherein items on lists comprise songs.

7. The system of claim 1, wherein items on lists comprise movies.

8. The system of claim 1, wherein items on lists comprise books.

9. The system of claim 1, wherein items on lists comprise hard goods.

10. The system of claim 1, wherein the lists include reviews of items on the list.

11. A method for organizing and distributing lists of linked content;
providing means for a user to build one or more lists of purchasable items;
allowing the user to associate an original review with each item on a list;
providing consumers with a means to view lists and make purchases of items directly from each list; and
compensating a user who built a list with a sales commission where one or more items are purchased by a consumer from the list.

12. The method of claim 11, further comprising providing a means for allowing individuals or other entities to register as users of the system.

13. The method of claim 11, further comprising allowing commissions for a user to accumulate within the system and to be paid to the user in a lump sum.

14. The method of claim 11, where the items are downloadable digital assets embedded in a list.

15. The method of claim 11, where there is no digital content, and the review is a recommendation of a live or offline event

16. The method of claim 12, where users are automatically registered, by way of subscribing to another service.

17. The method of claim 12, where users are automatically registered, by way of registering on a different Web site.

18. The method of claim 12, where users are automatically registered, by way of being or becoming the customer of another product or service.
